(19) United States
(12) Patent Application Publication
(10) Pub. No.: US 2014/0075559 A1
(43) Pub. Date: Mar. 13, 2014

(54) METHOD AND DEVICE FOR PROCESSING VIRUS-INFECTED APPLICATIONS

(71) Applicant: Tencent Techonology (Shenzhen) Co., Ltd., Shenzhen (CN)

(72) Inventors: Ting An YAO, Shenzhen (CN); Zhao Hua Lu, Shenzhen (CN); Hui Juan Zheng, Shenzhen (CN)

(73) Assignee: Tencent Techonology (Shenzhen) Co., Ltd., Shenzhen (CN)

(21) Appl. No.: 14/054,559

(22) Filed: Oct. 15, 2013

Related U.S. Application Data
(63) Continuation of application No. PCT/CN2013/081901, filed on Aug. 20, 2013.

(30) Foreign Application Priority Data
Sep. 7, 2012 (CN) 201210330224.X

(51) Int. Cl. G06F 21/56

(52) U.S. Cl. CPC G06F 21/568
USPC 726/24

(57) ABSTRACT

The present disclosure relates to a virus-infected application processing method. The method comprises: obtaining identification information associated with a virus-infected application; cleaning the virus-infected application; sending the identification information to a recommended application search module; receiving recommendation information from the recommended application search module, the recommendation information comprising introduction to one or more applications relevant to the virus-infected application; and displaying the recommendation information. According to the virus-infected application processing method, relevant applications are recommended to a user at the same time as the virus-infected application is cleaned, thereby allowing the user to easily install a same but virus-free application or a similar substitute application. The entire operational process is simple and convenient, and can effectively make up for the functional loss due to the cleaning of the virus-infected application. In addition, the present disclosure provides a virus-infected application processing device.

### CROSS REFERENCE TO RELATED APPLICATION

This application is a U.S. continuation application under 35 U.S.C. §111(a) claiming priority under 35 U.S.C. §§120 and 365(c) to International Application No. PCT/CN2013/081901 filed Aug. 20, 2013, which claims the priority benefit of Chinese Patent Application No. 201210330224.X, filed Sep. 7, 2012, the contents of both the PCT application and the Chinese application are incorporated by reference herein in their entirety for all purposes.

### TECHNICAL FIELD

The present disclosure relates generally to the antivirus technological field, and more particularly, to a method, device, and system for processing virus-infected applications.

### BACKGROUND

In most virus-infected mobile phone applications, the application program itself and the virus program are packaged together. As a result, in order to clean the virus, the virus-infected application needs to be uninstalled as well. This causes certain loss to user functionalities, and the user needs to download a same or similar substitute application. Not only is the operation cumbersome, it is also possible that the user may download a virus-infected application again when downloading the application.

### SUMMARY OF THE DISCLOSURE

There is a need for a method, device, and system for processing virus-infected applications. The method, device, and system disclosed herein can recommend to a user one or more relevant applications when cleaning a virus-infected application, thereby allowing the user to easily install a same but virus-free application or a similar substitute application.

A virus-infected application processing method comprises: obtaining identification information associated with a virus-infected application; cleaning the virus-infected application; sending the identification information to a recommended application search module; receiving recommendation information from the recommended application search module, wherein the recommendation information comprises introduction to one or more applications relevant to the virus-infected application; and displaying the recommendation information.

A virus-infected application processing device comprises: an identification information obtaining module that obtains identification information associated with a virus-infected application; an infected application cleaning module that cleans the virus-infected application; an identification information sending module that sends the identification information to a recommended application search module; a recommendation information receiving module that receives recommendation information from the recommended application search module, wherein the recommendation information comprises introduction to one or more applications relevant to the virus-infected application; and a recommendation information display module that displays the recommendation information.

A virus-infected application processing system comprises a processing device and an application recommending server, wherein the processing device comprises: an identification information obtaining module that obtains identification information associated with a virus-infected application; an infected application cleaning module that cleans the virus-infected application; an identification information sending module that sends the identification information to the application recommending server, the application recommending server comprises: a recommended application search module that receives the identification information from the processing device, searches relevant applications based on the received identification information, generates corresponding recommendation information and sends the generated recommendation information to the processing device, wherein the recommendation information comprises introduction to one or more applications relevant to the virus-infected application, and the processing device further comprises: a recommendation information receiving module that receives the recommendation information from the recommended application search module; and a recommendation information display module that displays the recommendation information.

According to the method and in the device and system for processing a virus-infected application, relevant applications are recommended to a user at the same time as the virus-infected application is cleaned, thereby allowing the user to easily install a same but virus-free application or a similar substitute application. The entire operational process is simple and convenient, and can effectively make up for the functional loss due to the cleaning of the virus-infected application.

### BRIEF DESCRIPTION OF THE DRAWINGS

FIG. 1 is a schematic diagram illustrating an example of the flow of a virus-infected application processing method according to various embodiments.

FIG. 2 is a schematic diagram illustrating an example of the flow of a method of searching relevant applications executed by a recommended application search module according to various embodiments.

FIG. 3 is a schematic diagram illustrating an example of an arrangement of a virus-infected application processing device according to various embodiments.

FIG. 4 is a schematic diagram illustrating an example of an arrangement of a virus-infected application processing system according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

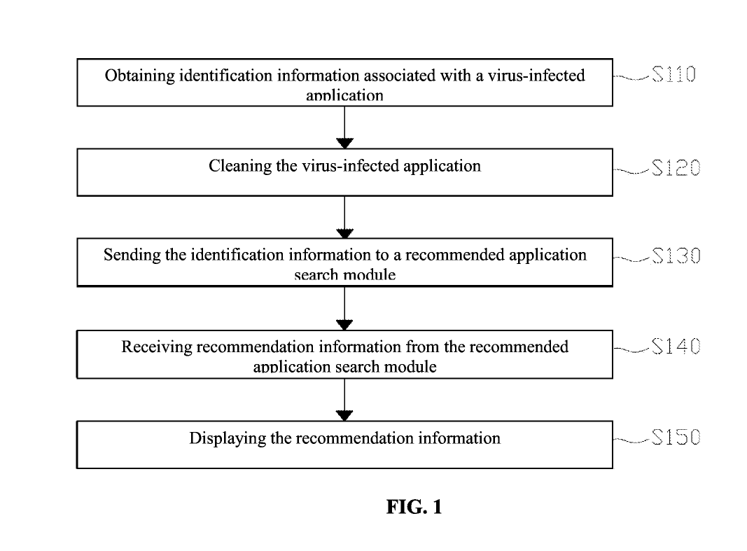

FIG. 1 is a schematic diagram illustrating an example of the flow of a virus-infected application processing method according to various embodiments. The method can be executed by an electronic device such as a computer, a smartphone, or a tablet PC, etc. According to some embodiments, the method can be executed by a mobile terminal. A mobile terminal can be a mobile phone, a tablet PC, a media player, etc. Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), a media player (including, but not limited to, Apple iPod and Microsoft Zoom), or an on-vehicle device running any of the above-mentioned operating systems or any other operating systems, or any other mobile Internet device (“MID”) or intelligent communication terminal, all of which are well known to those skilled in the art. As illustrated in FIG. 1, the virus-infected application processing method can comprise the following steps:

Step S110: obtaining identification information associated with a virus-infected application. According to some embodiments, the virus-infected application can be identified by antivirus software. According to these embodiments, the identification information associated with the virus-infected application can be obtained after the antivirus software identifies the virus-infected application. Examples of such identification information include, but are not limited to, a name and version of the virus-infected application, a program package name, a certificate, or a feature code, such as a message-digest algorithm 5 (“MD5”) feature code.

Step S120: cleaning the virus-infected application. According to some embodiments, cleaning the virus-infected application comprises completely uninstalling the virus-infected application. This is a common method of cleaning a virus-infected application in the antivirus field, and the method is well known to those skilled in the art.

Step S130: sending the identification information to a recommended application search module. According to some embodiments, the recommended application search module can be installed locally, e.g., in the same device in which the virus-infected application was installed. For example, the recommended application search module can be a functional module of antivirus software. According to some other embodiments, the recommended application search module can be installed in a remote server. According to some embodiments, the recommended application search module can searches in an application library for applications relevant to the virus-infected application and generate recommendation information based on one or more found applications. According to some embodiments, the application library can be stored in a remote server. Therefore, regardless of whether the recommended application search module is installed locally or remotely, it can search data in an application library stored in a remote server.

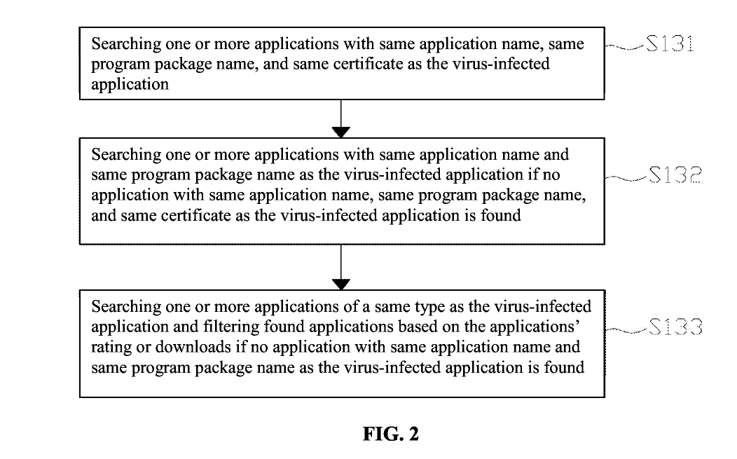

FIG. 2 is a schematic diagram illustrating an example of the flow of a method of searching relevant applications executed by a recommended application search module according to various embodiments. As illustrated in FIG. 2, the method can comprise:

Step S131: searching one or more applications with same application name, same program package name, and same certificate as the virus-infected application.

Step S132: searching one or more applications with same application name and same program package name as the virus-infected application if no application with same application name, same program package name, and same certificate as the virus-infected application is found.

Step S133: searching one or more applications of a same type as the virus-infected application and filtering found applications based on the applications' rating or downloads if no application with same application name and same program package name as the virus-infected application is found.

The inclusion of a process of certificate verification in Step S131 ensures that any found application and the virus-infected application are published by the same person or organization. Therefore, the searching criteria pursuant to Step S131 are the strictest. Compared to Step S131, Step S132 does not include the process of certificate verification, but because it includes a process of verifying application name and program package name, it can find most repackaged applications. Step S133 can provide a user with even more choices because it can find some most popular applications (e.g., those with the highest ratings or the most downloads) based on the type of the virus-infected application and filtering of applications of the same type as the virus-infected application based on the applications' rating or downloads.

According to some embodiments, Steps S131-S133 can proceed as illustrated in FIG. 2, and different numbers of recommended applications can be provided for a user to select based on the user's selection along each step. Those skilled in the art can readily appreciate that a process of searching relevant applications is not limited to the one illustrated in FIG. 2. For example, part but not all of Steps S131-S133 can be adopted. According to some embodiments, other identification information such as one or more feature codes can be used for searching and verification.

After one or more relevant applications are found, the recommended application search module can generate recommendation information based on the one or more found applications and return the recommendation information. Examples of recommendation information include but are not limited to introduction to applications relevant to the virus-infected application and their download links.

Step S140: receiving recommendation information from the recommended application search module. According to the embodiments where the recommended application search module is installed locally, the recommendation information can be transmitted within a process or between processes. According to the embodiments where the recommended application search module is installed in a remote server, the recommendation information can be transmitted via a network.

Step S150: displaying the recommendation information. According to some embodiments, the recommendation information can be displayed in the form of a list to introduce the recommended applications. According to some embodiments, relevant applications can be automatically downloaded and installed after a user clicks a relevant link or button.

According to the above described virus-infected application processing method, relevant applications are recommended to a user at the same time as the virus-infected application is cleaned, thereby allowing the user to easily install a same but virus-free application or a similar substitute application. The entire operational process is simple and convenient, and can effectively make up for the functional loss due to the cleaning of the virus-infected application.

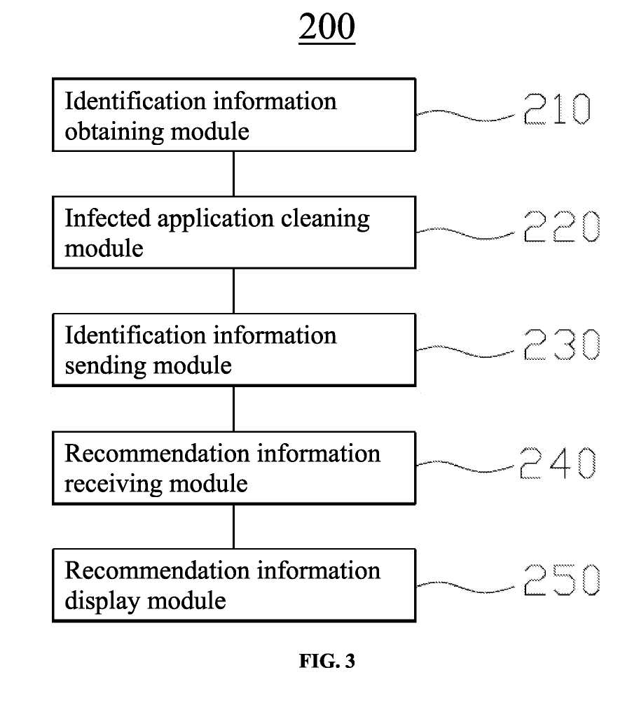

As illustrated in FIG. 3, a virus-infected application processing device 200 can comprise: an identification information obtaining module 210, an infected application cleaning module 220, an identification information sending module 230, a recommendation information receiving module 240, and a recommendation information display module 250.

The identification information obtaining module 210 obtains identification information associated with a virus-infected application. According to some embodiments, the virus-infected application can be identified by antivirus software. According to these embodiments, the identification information associated with the virus-infected application can be obtained after the antivirus software identifies the virus-infected application. Examples of such identification information include, but are not limited to, a name and version of the virus-infected application, a program package name, a certificate, or a feature code, such as a MD5 feature code.

The infected application cleaning module 220 cleans the virus-infected application. According to some embodiments, cleaning the virus-infected application comprises completely uninstalling the virus-infected application. This is a common method of cleaning a virus-infected application in the antivirus field, and the method is well known to those skilled in the art.

The identification information sending module 230 sends the identification information to a recommended application search module. According to some embodiments, the recommended application search module can be installed locally, e.g., in the same device in which the virus-infected application was installed. For example, the recommended application search module can be a functional module of antivirus software. According to some other embodiments, the recommended application search module can be installed in a remote server. According to some embodiments, the recommended application search module searches in an application library for applications relevant to the virus-infected application and generates recommendation information based on one or more found applications. According to some embodiments, the application library can be stored in a remote server. Therefore, regardless of whether the recommended application search module is installed locally or remotely, it can search data in an application library stored in a remote server.

FIG. 2 is a schematic diagram illustrating an example of the flow of a method of searching relevant applications executed by the recommended application search module according to various embodiments. As illustrated in FIG. 2, the method can comprise:

Step S131: searching one or more applications with same application name, same program package name, and same certificate as the virus-infected application.

Step S132: searching one or more applications with same application name and same program package name as the virus-infected application if no application with same application name, same program package name, and same certificate as the virus-infected application is found.

Step S133: searching one or more applications of a same type as the virus-infected application and filtering found applications based on the applications' rating or downloads if no application with same application name and same program package name as the virus-infected application is found.

The inclusion of a process of certificate verification in Step S131 ensures that any found application and the virus-infected application are published by the same person or organization. Therefore, the searching criteria pursuant to Step S131 are the strictest. Compared to Step S131, Step S132 does not include the process of certificate verification, but because it includes a process of verifying application name and program package name, it can find most repackaged applications. Step S133 can provide a user with even more choices because it can find some most popular applications (e.g., those with the highest ratings or the most downloads) based on the type of the virus-infected application and filtering of applications of the same type as the virus-infected application based on the applications' rating or downloads.

According to some embodiments, Steps S131-S133 can proceed as illustrated in FIG. 2, and different numbers of recommended applications can be provided for a user to select based on the user's selection along each step. Those skilled in the art can readily appreciate that a process of searching relevant applications is not limited to the one illustrated in FIG. 2. For example, part but not all of Steps S131-S133 can be adopted. According to some embodiments, other identification information such as one or more feature codes can be used for searching and verification.

After one or more relevant applications are found, the recommended application search module can generate recommendation information based on one or more found applications and return the recommendation information. Examples of recommendation information include but are not limited to introduction to applications relevant to the virus-infected application and their download links.

The recommendation information receiving module 240 receives the recommendation information from the recommended application search module, wherein the recommendation information comprises introduction to one or more applications relevant to the virus-infected application. According to the embodiments where the recommended application search module is installed locally, the recommendation information can be transmitted within a process or between processes. According to the embodiments where the recommended application search module is installed in a remote server, the recommendation information can be transmitted via a network.

The recommendation information display module 250 displays the recommendation information. According to some embodiments, the recommendation information can be displayed in the form of a list to introduce the recommended applications. According to some embodiments, relevant applications can be automatically downloaded and installed after a user clicks a relevant link or button.

In the above described virus-infected application processing device, relevant applications are recommended to a user at the same time as the virus-infected application is cleaned, thereby allowing the user to easily install a same but virus-free application or a similar substitute application. The entire operational process is simple and convenient, and can effectively make up for the functional loss due to the cleaning of the virus-infected application.

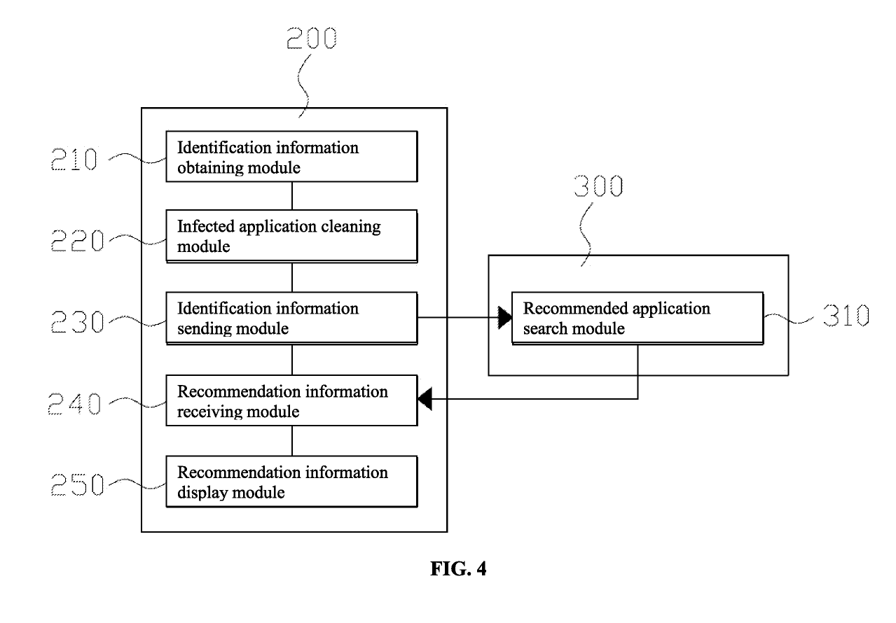

As illustrated in FIG. 4, a virus-infected application processing system comprises a processing device 200 illustrated in FIG. 3 and an application recommending server 300.

The processing device 200 has been described in detail hereinabove. The application recommending server 300 can comprise: a recommended application search module 310. The recommended application search module 310 receives identification information associated with the virus-infected application sent from the identification information sending module 230 in the processing device 200, searches relevant applications based on the identification information, generates recommendation information and returns the recommendation information to the processing device 200. According to some embodiments, the recommendation information can comprise introduction to one or more applications relevant to the virus-infected application.

According to some embodiments, the recommended application search module 310 searches applications relevant to the virus-infected application in an application library and generates recommendation information based on one or more found applications. According to some embodiments, the application library can be stored directly in the application recommending server or in a storage server in a cloud.

FIG. 2 is a schematic diagram illustrating an example of the flow of a method of searching relevant applications executed by the recommended application search module 310 according to various embodiments. As illustrated in FIG. 2, the method can comprise:

Step S131: searching one or more applications with same application name, same program package name, and same certificate as the virus-infected application.

Step S132: searching one or more applications with same application name and same program package name as the virus-infected application if no application with same application name, same program package name, and same certificate as the virus-infected application is found.

Step S133: searching one or more applications of a same type as the virus-infected application and filtering found applications based on the applications' rating or downloads if no application with same application name and same program package name as the virus-infected application is found.

The inclusion of a process of certificate verification in Step S131 ensures that any found application and the virus-infected application are published by the same person or organization. Therefore, the searching criteria pursuant to Step S131 are the strictest. Compared to Step S131, Step S132 does not include the process of certificate verification, but because it includes a process of verifying application name and program package name, it can find most repackaged applications. Step S133 can provide a user with even more choices because it can find some most popular applications (e.g., those with the highest ratings or the most downloads) based on the type of the virus-infected application and filtering of applications of the same type as the virus-infected application based on the applications' rating or downloads.

According to some embodiments, Steps S131-S133 can proceed as illustrated in FIG. 2, and different numbers of recommended applications can be provided for a user to select based on the user's selection along each step. Those skilled in the art can readily appreciate that a process of searching relevant applications is not limited to the one illustrated in FIG. 2. For example, part but not all of Steps S131-S133 can be adopted. According to some embodiments, other identification information such as one or more feature codes can be used for searching and verification.

According to some embodiments, after finding one or more relevant applications, the recommended application search module 310 can generate recommendation information based on the found one or more applications and return the recommendation information to the recommendation information receiving module 240 in the processing device 200.

In the above described virus-infected application processing system, relevant applications are recommended to a user at the same time as the virus-infected application is cleaned, thereby allowing the user to easily install a same but virus-free application or a similar substitute application. The entire operational process is simple and convenient, and can effectively make up for the functional loss due to the cleaning of the virus-infected application.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A virus-infected application processing method comprising:
obtaining identification information associated with a virus-infected application,
cleaning the virus-infected application,
sending the identification information to a recommended application search module,
receiving recommendation information from the recommended application search module, wherein the recommendation information comprises introduction to one or more applications relevant to the virus-infected application, and
displaying the recommendation information.

2. The method of claim 1, wherein the identification information comprises at least one of a name and version of the virus-infected application, a program package name, a certificate, and a feature code.

3. The method of claim 1, wherein cleaning the virus-infected application comprises uninstalling the virus-infected application.

4. The method of claim 1, wherein the recommended application search module is installed locally.

5. The method of claim 1, wherein the recommended application search module is installed in a remote server.

6. The method of claim 1, wherein displaying the recommendation information comprises displaying the recommendation information in the form of a list.

7. A virus-infected application processing method comprising:
receiving identification information associated with a virus-infected application from a terminal,
searching in an application library for one or more applications relevant to the virus-infected application,
generating recommendation information based one or more found applications, wherein the recommendation information comprises introduction to the one or more found applications, and
sending the recommendation information to the terminal.

8. The method of claim 7, wherein searching in an application library for one or more applications relevant to the virus-infected application comprises searching one or more applications with same application name, same program package name, and same certificate as the virus-infected application.

9. The method of claim 8, wherein searching in an application library for one or more applications relevant to the virus-infected application comprises searching one or more applications with same application name and same program package name as the virus-infected application if no application with same application name, same program package name, and same certificate as the virus-infected application is found.

10. The method of claim 7, wherein searching in an application library for one or more applications relevant to the virus-infected application comprises:
searching one or more applications of a same type as the virus-infected application, and
filtering found applications based on the applications' rating or downloads.

11. A virus-infected application processing device comprising:
an identification information obtaining module that obtains identification information associated with a virus-infection application,
an infected application cleaning module that cleans the virus-infected application,
an identification information sending module that sends the identification information to a recommended application search module,
a recommendation information receiving module that receives recommendation information from the recommended application search module, wherein the recommendation information comprises introduction to one or more applications relevant to the virus-infected application, and
a recommendation information display module that displays the recommendation information.

12. The device of claim 11, wherein the identification information comprises at least one of a name and version of the virus-infected application, a program package name, a certificate, and a feature code.

13. The device of claim 11, wherein the infected application cleaning module uninstalls the virus-infected application.

14. The device of claim 11, wherein the recommended application search module is installed locally in the device.

15. The device of claim 11, wherein the recommended application search module is installed in a remote server.

16. The device of claim 11, wherein the recommendation information display module displays the recommendation information in the form of a list.
